(19) United States
(12) Patent Application Publication
(10) Pub. No.: US 2023/0051169 A1
(43) Pub. Date: Feb. 16, 2023

(54) CONFLICT DE-ESCALATION TRAINING SYSTEM AND METHOD

(71) Applicant: SimIS, Inc., Portsmouth, VA (US)

(72) Inventors: Johnny Garcia, Suffolk, VA (US); Max C. Luu, Beaverton, OR (US); Javaud A. Ahangari, Chesapeake, VA (US); Casey H. Batten, Virginia Beach, VA (US); Eric T. Reed, Suffolk, VA (US); Shawn T. Lirette, Hampton, VA (US)

(21) Appl. No.: 17/551,330

(22) Filed: Dec. 15, 2021

Related U.S. Application Data
(60) Provisional application No. 63/259,786, filed on Aug. 12, 2021.

(51) Int. Cl. G06Q 10/10; G06Q 50/26

(52) U.S. Cl. CPC G06Q 10/105; G06Q 50/26

(57) ABSTRACT

A conflict de-escalation training system includes a reproducer of sound and images and at least one device adapted to detect speech, proximity, and movement of a human trainee relative to the reproducer. Database(s) store trigger event definitions and natural language understanding (NLU) rules. A trigger analyzer determines when one of the trigger event definitions is satisfied by trainee’s speech/actions. An intent analyzer ascertains intent of the trainee’s speech using the NLU rules. A compliancy state generator determines a state value based on at least one of the intent of the trainee’s speech, proximity, and movement. The state value indicates a level of compliance of an imaginary individual being subjected to the trainee’s speech/actions. An output generator generates facial images and speech responses for the imaginary individual based on the state value. The facial images and speech responses are provided to the reproducer for output thereby.

Pursuant to 35 U.S.C. §119, the benefit of priority from provisional application 63/259,786, with a filing date of Aug. 12, 2021, is claimed for this non-provisional application.

### FIELD OF THE INVENTION

The invention relates generally to conflict resolution training, and more specifically to a training system and method that trains conflict-response professionals how to speak and act in ways that can aid in the de-escalation of a variety of conflict scenarios.

### BACKGROUND OF THE INVENTION

Law enforcement, security, and mental health professionals are frequently confronted with individuals in conflict or in an emotional situation that requires the professional to intercede with the goal of remedying or at least diminishing the conflict or emotional situation to a level of normalcy that is compliant with local laws and/or directives. It is not enough for these professionals to be “book” educated with the local laws and/or directives. That is, book educations must be reinforced with interactive situational training in order for the professionals to gain the operational expertise and interpersonal skills needed for the critical initial engagement with individuals in conflict, and the subsequent shaping and control of a potential conflict scenario.

Current conflict-situation training approaches include lecture-style classes, live role-playing sessions, and computer-based role-playing programs. However, each of these approaches falls short of being an effective conflict de-escalation training tool. For example, lecture-style classes merely provide non-interactive education in local laws and/or directives along with suggestions of how to engage an individual in a conflict or in an emotional situation and approaches to ensure governance compliance. Thus, the classes only provide “book” knowledge with no “hands-on” interactive training that is crucial if law enforcement, security, and mental health professionals are to be trained in de-escalation tactics.

Live role-playing sessions employ human actors or role players that attempt to simulate how an individual speaks and acts in a conflict or emotional situation. However, this type of training is completely dependent on how well an actor/role player plays their part and stays “in character”. Unfortunately, both of these requirements can be very difficult to achieve, especially when the actor/role player is known to the trainee or is used over and over for multiple trainees. More importantly, it is extremely difficult for a live actor to repeat their role multiple times in order to train different approaches to de-escalation of an event or type of situation. In addition, actors and role players generally have a limited repertoire of personality and response presentations, thereby limiting the breadth of conflict or emotional situation experiences that can be provided for a trainee.

Computer-based role-playing programs generally provide a trainee with an interactive training session in front of a computer and its display. The computer will typically be programmed with a variety of conflict or emotional situation events where each such event is defined by a pre-determined tree structure of operational events based on event responses. That is, a trainee’s responses during the course of an event cause the program to traverse a pre-determined path. However, these programs do not dynamically adjust the event-response tree structure and, therefore, cannot provide a trainee with a training scenario that can be different every time. Thus, the value of computer-based role-playing programs is greatly diminished after a trainee has trained a couple of times on a type of event.

### SUMMARY OF THE INVENTION

Accordingly, it is an object of the present invention to provide a system and method for conflict de-escalation training.

Another object of the present invention is to provide a conflict de-escalation training system and method that dynamically teaches a conflict resolution trainee how to speak and act in ways that will likely lead an individual in crisis toward a behavior that is more in compliance with local laws and/or directives, acceptable behavior, and the training goals and standards established for the trainee.

Still another object of the present invention is to provide a conflict de-escalation training system and method that adjusts to the speech and actions of a trainee.

Yet another object of the present invention is to provide a conflict de-escalation training system and method that provides robotic speech and actions in response to the speech and actions of a trainee.

Other objects and advantages of the present invention will become more obvious hereinafter in the specification and drawings.

In accordance with the present invention, a conflict de-escalation training system includes a reproducer of sound and images and at least one device adapted to detect speech, proximity, and movement of a human trainee relative to the reproducer. At least one database stores trigger event definitions and natural language understanding (NLU) rules. An intent analyzer, executed by the at least one hardware processor, ascertains an intent of the speech of the human trainee using the NLU rules. A trigger analyzer executed by at least one hardware processor generates a trigger enable flag when one of the trigger event definitions is satisfied by at least one of the speech, the proximity, and the movement of the human trainee. A compliancy state generator executed by the at least one hardware processor determines a state value when the trigger enable flag is generated. The state value is based on at least one of the intent of the speech, the proximity of the human trainee, and the movement of the human trainee. The state value is indicative of a level of compliance of an imaginary individual being subjected to the speech, the proximity, and the movement of the human trainee. An output generator, coupled to the reproducer and executed by the at least one hardware processor, generates a facial image and a speech response for the imaginary individual based on the state value. The facial image and speech response are provided to the reproducer for output thereby.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of a conflict de-escalation training system in accordance with an embodiment of the present invention;

FIG. 2 is a schematic view of a conflict de-escalation training system in accordance with another embodiment of the present invention;

FIG. 3A is a schematic view of a stationary base for the system’s sound and image reproducer in accordance with an embodiment of the present invention;

FIG. 3B is a schematic view of a stationary, adjustable-height base for the system’s sound and image reproducer in accordance with another embodiment of the present invention;

FIG. 3C is a schematic view of a stationary base to include a mechanized-arm, humanoid dummy for the system’s sound and image reproducer in accordance with another embodiment of the present invention;

FIG. 3D is a schematic view of a mobile base to include a mechanized-arm, humanoid dummy for the system’s sound and image reproducer in accordance with another embodiment of the present invention;

FIG. 4 illustrates a schematic layout of a database and processing apparatus of the conflict de-escalation training system in accordance with an embodiment of the present invention;

FIG. 5 illustrates a flowchart of an artificial intelligence method for conflict de-escalation training in accordance with an embodiment of the present invention; and

FIG. 6 is a schematic view of a conflict de-escalation training system having trainee speech and action recording capabilities in accordance with another embodiment of the present invention.

### DETAILED DESCRIPTION OF THE INVENTION

The present invention is a conflict de-escalation training system and method. The term “conflict” as used herein refers to any type of interpersonal engagement between a professional (e.g., police, security personnel, mental health worker, etc.) and an individual who is in an emotional state or may enter an emotional state due to the presence of or engagement with the professional or an external event/stimuli causing the initial emotional state. The term “de-escalation” as used herein refers to a reduction or possible prevention of the conflict by virtue of the professional’s selected use of speech and actions.

The system and method provide a human trainee (hereinafter referred to simply as “trainee”) an interactive experience with an imaginary individual (hereinafter referred to as “trainer bot”) presented on a “platform” that the trainee must initially engage and then interact with over the course of an event. Briefly, the present invention makes each engagement/interaction event a dynamic training session that allows a trainee to see in real-time how his/her speech and actions affect speech (and actions in some embodiments) of the trainer bot as the trainer bot becomes more compliant or less compliant in response to the trainee’s speech and actions. As used herein, “speech” of the trainee or trainer bot includes any words, utterances, any type of verbalized sounds, etc.

As used herein, the words “compliant” or “compliance” are defined in terms of an individual’s emotional and/or physical behavior being in compliance or non-compliance with one or more of an inquiry and/or demand of the trainee. For example, a trainee’s inquiries and/or demands could be in accordance with local laws and/or directives. The local laws and/or directives are those that the trainee is trying to advance and encourage during a conflict-type engagement and interaction with the goal of reducing or preventing conflict in the engagement/interaction. However, in other instances, a trainee may make an inquiry and/or demand that an engaged individual is not required to answer under local laws and/or directives. Since one’s individual compliance is not binary (i.e., compliance is not generally one of full compliance or fully non-compliant), the present invention’s system and method dynamically and incrementally adjust the trainer bot’s level of compliance in real-time so that a trainee receives real-time feedback for their choice of speech and actions.

As mentioned above, the trainer bot presents on a “platform” that can be realized in a variety of ways without departing from the scope of the present invention. By way of illustration, several non-limiting platform embodiments will be described herein. At a minimum, the platform is a reproducer of sound and images that can be seen/heard by the trainee during a training session. In general, the images are facial images of a human face, and the sound is the speech (e.g., recordings, synthesized speech, etc.) emanating from the images of the human face. That is, the reproducer produces speech sounds and coordinated facial images of an imaginary individual where the speech sounds and facial images are those of the trainer bot. In some embodiments of the present invention, the facial images and sounds are coordinated with one another in a video stream of facial movements associated with the coordinated speech. In some embodiments of the present invention , the reproducer is mounted on a base with the base positioning the reproducer at a fixed or variable height above a ground surface to simulate a particular height of a trainer bot’s “face” commensurate with a person being in one of a standing, sitting, or lying down position. In some embodiments of the present invention, the base is a mobile base capable of motorized movement on a ground surface where such motorized base movement is coordinated with the sound/images on the reproducer as will be explained further below. In some embodiments of the present invention, the base can include a humanoid dummy with the reproducer being positioned at the head location of the dummy. In some embodiments of the present invention, a base’s humanoid dummy can have mechanized arms whose movements are coordinated with sound/images on the reproducer as will be explained further below. In some embodiments of the present invention, a mobile base capable of motorized movement supports a humanoid dummy having mechanized arms where the base’s motorized movements as well as those of the mechanized arms are coordinated with sound/images on the reproducer as will be explained further below.

In some embodiments of the present invention, the conflict de-escalation training system and method will employ artificial intelligence (“AI”) and machine learning (“ML”) apparatus and methods using non-transitory computer readable media storing machine readable and executable instructions that provide Al and ML-based conflict de-escalation training in accordance with the present invention. In terms of the apparatus and methods using such non-transitory computer readable media, the elements thereof can be realized by any combination of hardware processors and programming to implement the elements’ functionalities. Such combinations include, but are not limited to, processor-executable instructions stored on a non-transitory machine-readable medium and one or more hardware processors for executing the instructions. The instructions can be stored at the processor(s) or separate from the processor(s) without departing from the scope of the present invention. The one or more hardware processors can be co-located at local or remote locations or can be located at a combination of local and remote locations without departing from the scope of the present invention. For example, a remote special-function hardware processor could be used to improve the efficacy and efficiency of an element’s functionality. Still further and in some cases, an element’s functionality can be implemented in on-board circuitry of the trainer bot.

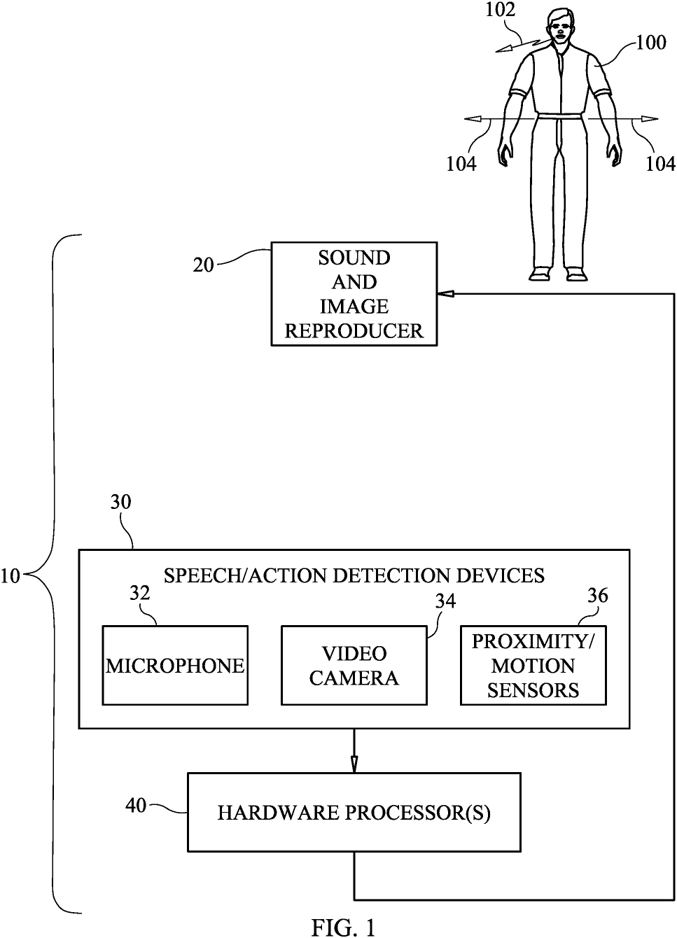

Referring now to the drawings and more particularly to FIG. 1, a conflict de-escalation training system in accordance with an embodiment of the present invention is shown and is referenced generally by numeral 10. System 10 is the above-described trainer bot that provides conflict de-escalation training for a trainee 100. During a typical training session, trainee 100 speaks (as indicated by arrow 102) and moves (as indicated by arrows 104). Speech 102 and movement 104 (e.g., movement of trainee 100 towards/away from system 10, movement of body parts of trainee 100, or combinations thereof) are detected, analyzed, and used by system 10 to provide trainer bot responses to speech 102 and/or movement 104 of trainee 100. This interactive cycle between the trainee 100 and system 10 continues during an entire training session.

System 10 includes a sound and image reproducer 20, one or more speech/action detection devices 30, and one or more hardware processors 40. Reproducer 20 can be any audio/image/video reproduction device or combination of devices that can reproduce speech sounds and facial images/videos. Devices 30 detect speech 102 of trainee 100, the proximity of trainee 100 relative to reproducer 20, and movement 104 of trainee 100. By way of an illustrative example, devices 30 can include a microphone 32, a video camera 34, and proximity/motion sensors 36 (e.g., Light Detection and Ranging (LIDAR) device or sonar-based sensors). As used herein, the term “proximity” includes the sensing of threshold distances (e.g., at least 3 feet away, less than 6 feet away, etc.) and/or an actual spatial separation distance between the trainee and trainer bot. Devices 30 could also include accelerometers for detecting quick or sudden movements of trainee 100 where fast movements could be indicative of the trainee’s intent used by system 10 when generating a trainer bot’s responses as will be explained further below. Devices 30 can be completely co-located with reproducer 20, completely remotely-located with respect to reproducer 20, or can be realized by a combination of co-located and remotely-located devices without departing from the scope of the present invention. Hardware processors 40 can be any processing device, and can be completely co-located with reproducer 20, completely remotely-located with respect to reproducer 20, or can be realized by a combination of co-located and remotely-located hardware processors without departing from the scope of the present invention.

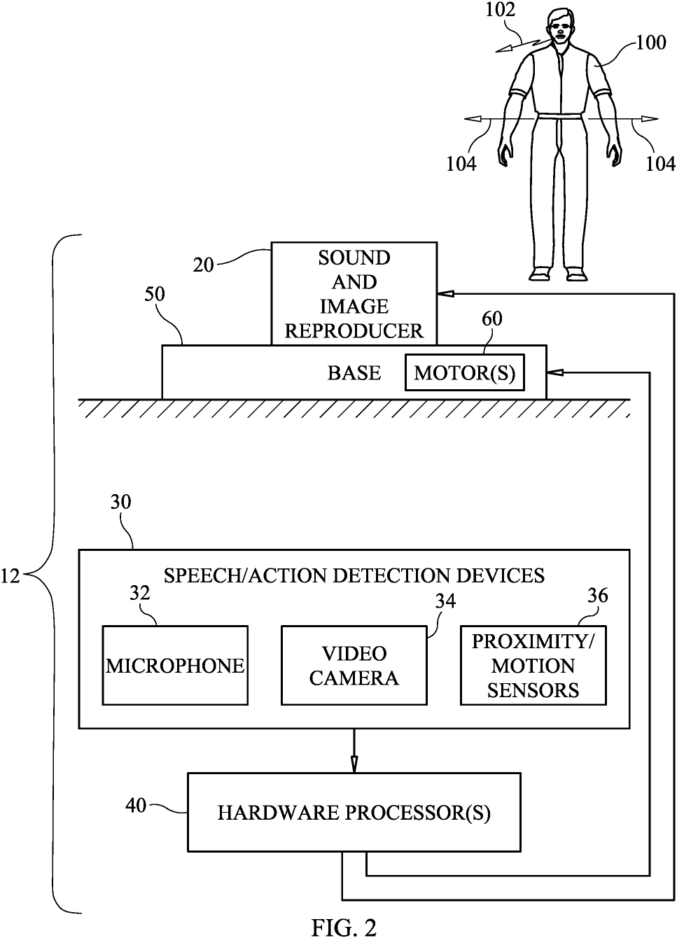

In some embodiments of the present invention and as illustrated in FIG. 2, a conflict de-escalation training system 12 includes a base 50 positioned on a ground surface 200. Reproducer 20 is coupled to or mounted on base 50 at a height above ground surface 200. Base 50 can be configured and constructed in a variety of ways without departing from the scope of the present invention. For example, base 50 can be configured as a simple stationary base, configured to provide one or more of height adjustability of reproducer 20 relative to ground surface 200, configured for controlled (motorized) movement on ground surface 200, or configured for controlled (mechanized) movement of parts of base 50 as will be explained further below. For embodiments of the present invention providing controlled movement of base 50 and/or parts thereof, one or more hardware processors 40 control such movements using, for example, one or more motors 60 provided at base 50 as will be explained further below.

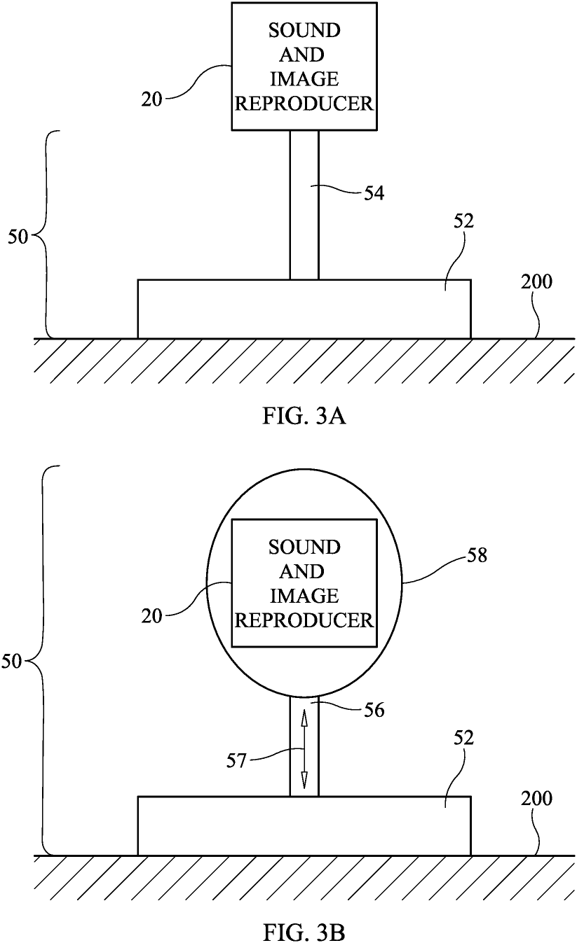

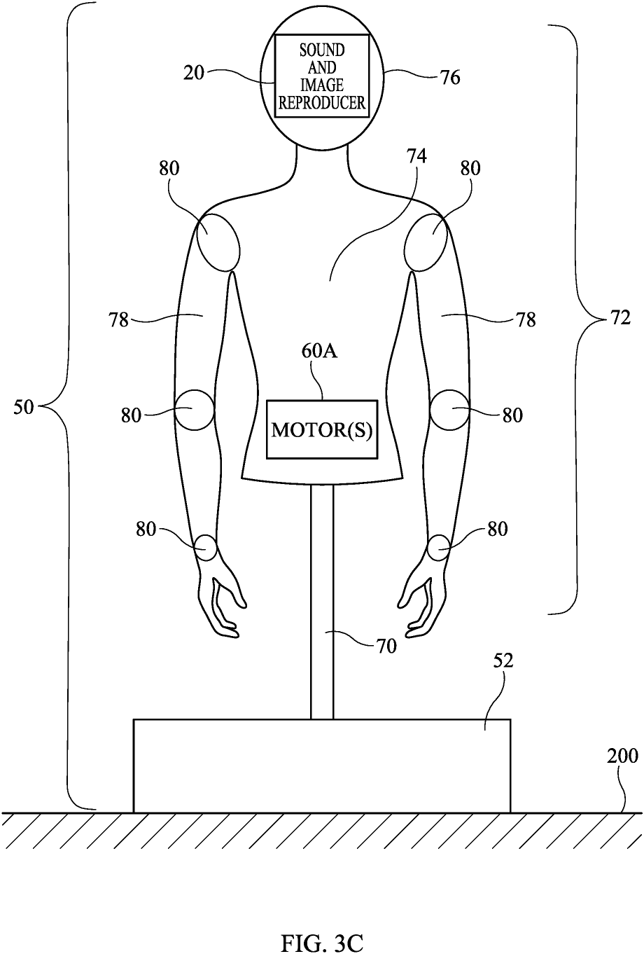

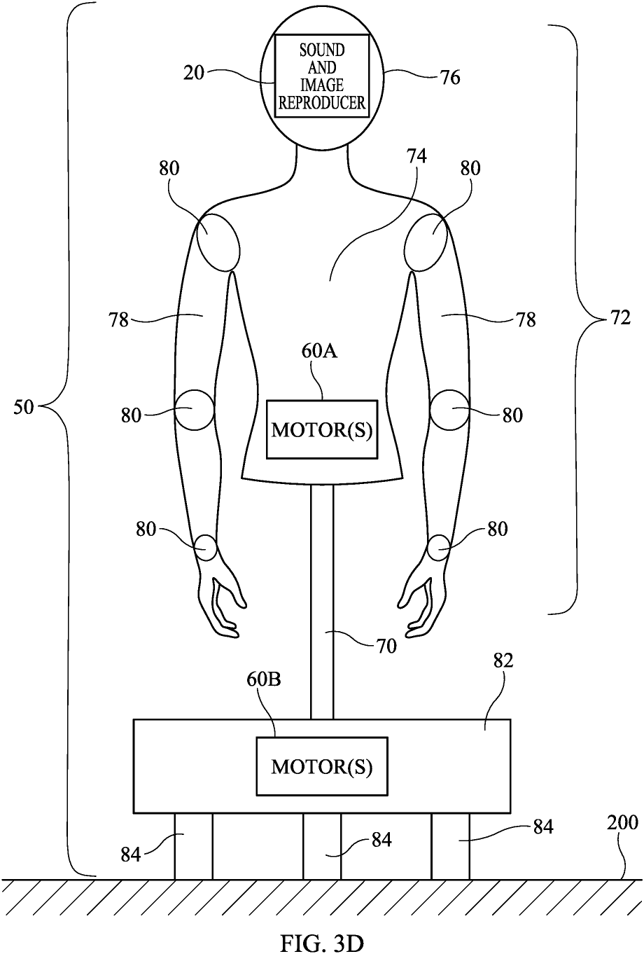

A number of non-limiting embodiments of base 50 are illustrated schematically in FIGS. 3A-3D. FIG. 3A illustrates a first type of base 50 having a stationary lower support 52 resting on a ground surface 200 and a fixed-length upper support 54 coupled to lower support 52. Reproducer 20 is mounted to the top of upper support 54 at a fixed height above ground surface 200. In some embodiments of the present invention, reproducer 20 can be incorporated into a dummy head (not shown in FIG. 3A) with the image display portion of reproducer 20 occupying what would be the facial region of the dummy head.

FIG. 3B illustrates a second type of base 50 having stationary lower base 52, a variable-length upper support 56 (e.g., telescoping, multi-section, etc.) that can be increased or decreased in length as indicated by two-headed arrow 57, and a humanoid dummy head 58 mounted atop upper support 56. Reproducer 20 is coupled to humanoid dummy head 58 with its image display portion positioned such that facial images presented thereon appear to be the face of humanoid dummy head 58. Differences in height between a trainee and the training bot can be significant as they may influence a trainee’s selection of proximity, spatial separation, and tone/volume of utterances to the training bot in order to evidence control, confidence, and elicit training bot compliance in the training event.

FIGS. 3C and 3D illustrate base embodiments capable of physical movement responses in addition to the speech and facial image responses at reproducer 20. More specifically, FIG. 3C illustrates a third type of base 50 that includes stationary lower support 52, a torso support 70 coupled to lower support 52, and a humanoid dummy 72 mounted atop support 70. For example, humanoid dummy 72 can have a torso portion 74, a head portion 76 with reproducer 20 coupled thereto to form the “face” thereof, and mechanized arms 78. In general, each of mechanized arms 78 is capable of independent controlled movement at one or more of the arm’s shoulder, elbow, and wrist having movable joint structures 80 that are controlled by motor(s) 60A mounted somewhere in base 50. Operation of motor(s) 60A is controlled by hardware processor(s) 40 (FIG. 2) as mentioned above. For clarity of illustration, connections between motor(s) 60A and joint structures 80 are omitted.

FIG. 3D illustrates a fourth type of base 50 that includes a mobile motorized lower support 82 and the above-described humanoid dummy 72 mounted atop support 70. Support 82 is supported on ground surface 200 by a multi-wheel structure 84 (e.g., motorized wheels, motorized and un-motorized wheels, motorized wheels and free-wheeling casters or balls, etc.) controlled by motor(s) 60B. Operation of motor(s) 60B is controlled by hardware processors 40 (FIG. 2) as mentioned above. For clarity of illustration, connections between motor(s) 60B and wheel structure 84 are omitted.

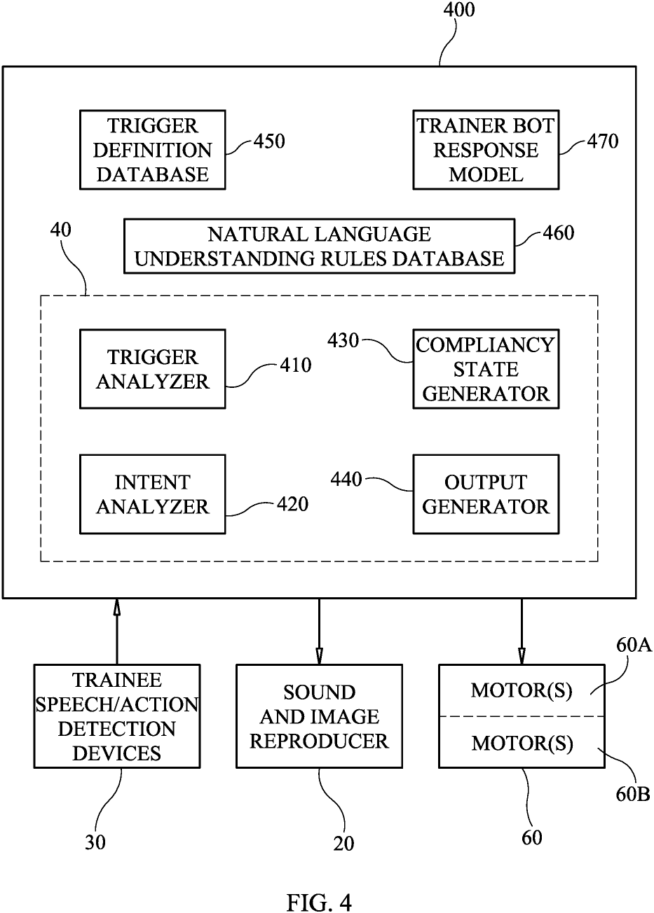

Referring now to FIG. 4, a schematic layout is illustrated of a database and processing apparatus 400 of a conflict de-escalation training system in accordance with an embodiment of the present invention. For a comprehensive understanding of the present invention, apparatus 400 will be described for use with a mobile base having a mechanized-arm humanoid dummy mounted thereon as described above and illustrated in FIG. 3D. However, it is to be understood that apparatus 400 can be adapted to work with any of the other base configurations (e.g., FIGS. 3A-3C) contemplated by the present invention.

Apparatus 400 provides the functional elements for the system and method of the present invention. The four essential elements include a trigger analyzer 410, an intent analyzer 420, a compliancy state generator 430, and an output generator 440. Each of the functional elements is executed by one or more of the above-described hardware processors 40 (FIGS. 1 and 2) executing machine-readable instructions stored on some non-transitory computer readable media.

Apparatus 400 also provides databases of information used by the functional elements during an event training session. The two essential databases include a trigger definition database 450 and a “natural language understanding” (“NLU”) rules database 460. Trigger definition database 450 defines trainee speech (e.g., words, phrases, utterances, etc.) and types of trainee actions (e.g., types of body movements, movement towards/away from trainer bot, etc.) that, when detected/satisfied, cause the generation of a trigger enable flag indicating that the trainee’s speech and/or actions will impact the compliancy state of the trainer bot as will be explained further below. NLU rules database 460 can be an existing or developed set of rules that map speech words/phrases to an intent associated with the words phrases. In some embodiments, NLU rules database 460 can be accessed from a third party provider via the internet or other network device. In some embodiments, one or both of databases 450 and 460 can be continually updated using ML technologies applied during event training sessions. In this way, the databases adapt to local speech patterns and dialects, local laws, and/or local directives for a particular organization.

Trigger definition database 450 can be configured in a variety of ways without departing form the scope of the present invention. For example, trigger database 450 can be configured simply as a global set of trigger definitions that apply to a trainee’s speech/action intent regardless of the type of event scenario. However, in some embodiments of the present invention, trigger definition database 450 is divided into types of event scenarios (e.g., traffic stop, domestic dispute, engagement with a drunk and disorderly individual, engagement with an individual attempting to commit self-harm, etc.) where the same speech or action can have can have a different intent depending on the type of event scenario with which it is associated.

Apparatus 400 also includes a trainer bot response model 470 used by output generator 440 to generate trainer bot responses. Response model 470 can range from simple database structures storing predetermined responses to a large managed model that is continually updated using machine learning. Such a managed model is similar to a script having a finite number of phrases or “responses” where each response is categorized under an intent. For example, under a “Greetings” intent, the following phrases could be included: “Hello”, “How are you”, “Hi there”, “Nice to see you”, and “What do you want”. Upon activation of the “Greetings” intent, output generator 440 could be configured to choose from one of these five phrases at random. Action-based intents and responses can be handled in a similar fashion. The creator of a scenario can be responsible for generating a model with a script full of responses (e.g., phrases, actions, or phrases and actions) it wants the trainer bot to be able to say/perform. The creation of compliant and non-compliant responses under each intent provides for a well-rounded scenario. The compliancy state value can be used to determine which model is actively running. Intents and their subsequent responses can vary from model to model.

In general, apparatus 400 receives (trainee-generated) inputs from devices 30 and generates trainer bot responses for output to reproducer 20 and, when included in the system, one or more of motors 60A and 60B. Apparatus 400 performs these functions throughout a training event/session as will be described further below.

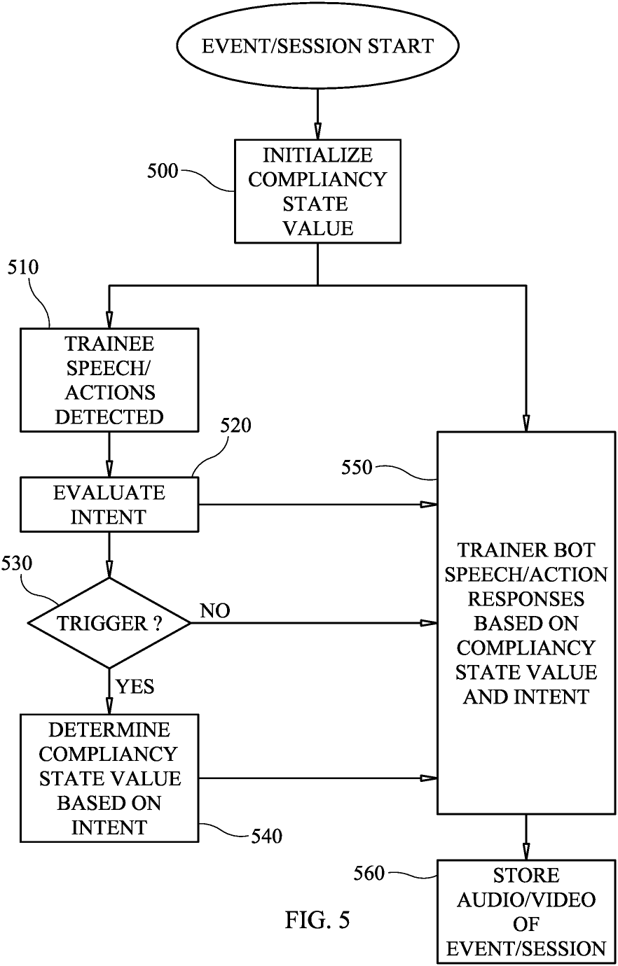

Referring additionally now to FIG. 5, a flowchart illustrates an AI method for a conflict de-escalation training event/session in accordance with an embodiment of the present invention. For a comprehensive understanding of the present invention, the flowchart assumes the method will be used in conjunction with a mobile base having a mechanized-arm humanoid dummy mounted thereon (FIG. 3D). However, it is to be understood that the method can be adapted to work with any of the other base configurations contemplated by the present invention.

At the start of a training event/session (FIG. 5), a compliancy state of an imaginary individual can be initialized at block 500 in accordance with the type of event and/or type of imaginary individual contemplated by the event. For purposes of the present invention, the compliancy state is a numeric value that indicates a level of compliance for the imaginary individual at any given time during an event. For example, a compliancy state could be a value between 1 and 10, where 1 could indicate a calm and fully compliant individual, while 10 could indicate an emotionally frantic and non-compliant individual. Values between 1 and 10 would then indicate incremental or sliding-scale levels of compliancy, where values closer to 1 indicate an individual who is closer to being compliant than non-compliant, while values closer to 10 indicate an individual who is closer to being non-compliant than compliant. Accordingly, for an event that likely begins with the trainer bot exhibiting a relatively high level of agitation, block 500 might initialize the compliancy state to a value of 8. In contrast, for an event that likely begins with the trainer bot exhibiting a calm demeanor, block 500 might initialize the compliancy state to a value of 1 or 2.

Following initialization of a compliancy state value for the event/session, the interactive portion of the event/session begins when a trainee speaks and/or acts/moves where such speech/actions are detected by the above-described devices 30 as indicated at block 510 in FIG. 5. For example, a trainee might speak an initial greeting directed at the trainer bot as the trainee’s position and movement relative to the trainer bot are detected. Processing is then passed to block 520 where intent analyzer 420 evaluates the intent of the trainee’s speech and/or actions. Since the trainee’s speech has the greatest impact during a real life event, intent analyzer 420 always functions to ascertain the intent of the trainee’s speech where such ascertained intent can then be evaluated to see if it satisfies a trigger definition in trigger definition database 450. In some embodiments, intent analyzer 420 can be additionally programmed to ascertain how the trainee’s proximity to the trainer bot and/or the trainee’s type and speed of movement impact intent. Intent of the trainee’s speech is ascertained using the rules in the NLU rules database 460. Techniques used to ascertain the intent of speech are known in the art and, therefore, will not be described further herein.

At decision block 530, trigger analyzer 410 evaluates one or more of the trainee’s speech/utterances, the trainee’s proximity to the trainer bot, and the trainee’s movements in front of the trainer bot to see if any of the trigger definitions (stored in database 450) are satisfied in which case a trigger enable flag is set so that processing proceeds to block 540. More specifically, trigger analyzer 410 compares one or more of the trainee’s speech, proximity, and movements with the various trigger enabling definitions in database 450. If decision block 530 indicates that a trigger definition is satisfied, processing proceeds to block 540 where a new compliancy state value is determined by compliancy state generator 430 based on the ascertained intent as will be explained further below. If no trigger definition is satisfied at decision block 530, the trigger enable flag is not set and the current compliancy state value remains the same and the trainer bot, at block 550, is free to generate a speech, base movement, and/or arm movement based on the current compliancy state value and intent analyzed by intent analyzer 420.

Determination of the compliancy state value at block 540 can be accomplished in a variety of ways without departing from the scope of the present invention. For example, in some embodiments of the present invention, each trigger-flag-enabling intent can have a corresponding compliancy state change value (e.g., +1, +2, +3, -1, -2, -3, etc.) assigned thereto that is used to increase or decrease the current compliancy state value. In other embodiments of the present invention, an algorithm can be employed at block 540 to determine the compliancy state value. By way of an illustrative example, one such algorithm has the following four variables:
the last changed compliancy state value L,
the current compliancy state value C,
a compliant threshold C_{T}, and
a non-compliant threshold N_{T}.

These values work in a relation-based formula to determine if the system should transition towards compliancy or non-compliancy. For example, if the value of C changes relative to the value of L (either from increasing or decreasing), the difference between L and C is checked against C_{T} and N_{T}. If the difference is greater than or equal to either of these thresholds, the compliancy state value will transition to match the crossed threshold, and the thresholds are updated. In still other embodiments of the present invention, changes in the thresholds can be tracked over time as a measure used to change compliancy.

Assuming decision block 530 indicates that a trigger definition is satisfied, processing is passed to block 540 where a new compliancy state value is determined by compliancy state generator 430 based on the ascertained intent as described above. Additionally or alternatively, some embodiments of block 540 could use the proximity of the trainee to the trainer bot and/or the trainee’s movements to determine an adjustment to the compliancy state value. For the illustrated embodiment where an event/session has an initialized compliancy state value, compliancy state generator 430 could positively or negatively increment the compliancy state value based on the ascertained intent. For embodiments where there is not an initialized compliancy state value, block 540 could determine the initial compliancy state value that would then be adjusted as the event/session continued.

The new or updated compliancy state value determined at block 540 (FIG. 5) is provided to output generator 440 (FIG. 4). As described above, output generator 440 accesses response model 470 and generates the trainer bot’s speech response, coordinated facial images, and coordinated base and arms movements at block 550. For example, if the trainee’s speech/actions caused the compliancy state value to move towards a non-compliant indication, a less compliant trainer bot response would be generated. However, if the trainee’s speech/actions caused the compliancy state value to move towards a more compliant indication, a more compliant trainer bot response would be generated. In this way, a trainee is immediately provided with trainer bot generated feedback related to the trainee’s speech/actions. The above-described process repeats throughout an entire event/session. In some embodiments of the present invention, provisions can be made to store audio and video recordings of an event/session at block 560 for later review and assessment.

As mentioned above, the present invention can employ ML techniques to continually update one or more of the databases to increase the AI capabilities of the system. For example, ML techniques could be used to update response model 470 and the NLU rules database 460 to improve the system’s ability to ascertain speech intent at block 520.

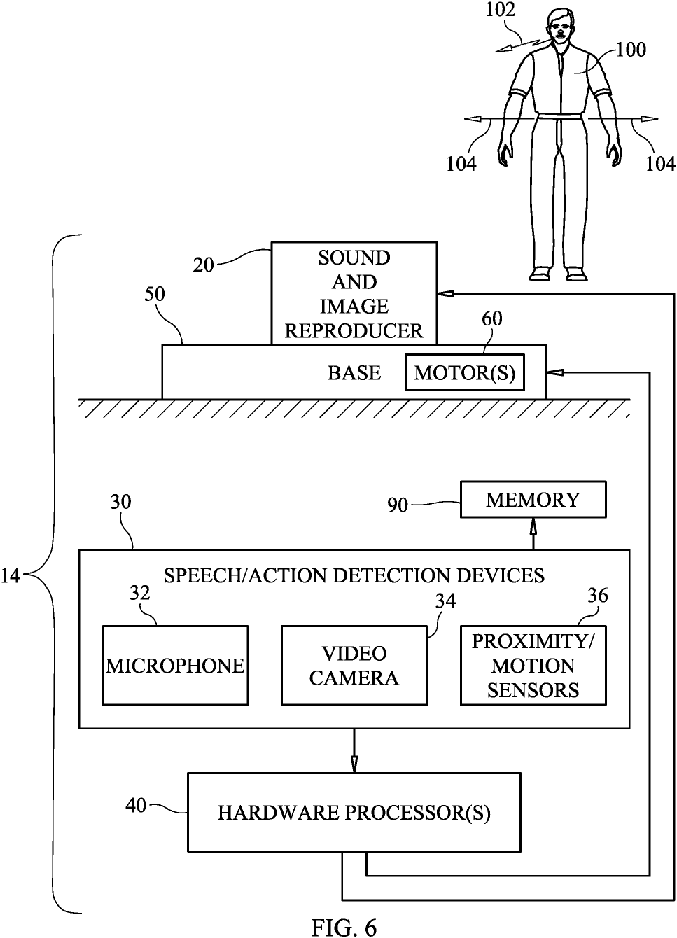

In some embodiments of the present invention and as mentioned above, a trainee’s speech and actions could be recorded and stored for later playback. The trainer bot’s speech and actions could also be recorded. In this way, a trainee can review an event/session with or without a live instructor to achieve a spectator’s perspective of their handling of an interactive event. Accordingly, FIG. 6 illustrates another conflict de-escalating training system 14 that further includes a local or remotely-located memory 90 coupled to, for example, devices 30 for archival storage of a trainee during and event/session. Memory 90 includes any hardware memory device or data storage application without departing from the scope of the present invention.

The advantages of the present invention are numerous. Conflict de-escalation training is predicated on how a trainee’s speech and actions affect a trainer bot’s compliancy state-based responses. Trainee feedback is instantaneous thereby encouraging a trainee to maintain or modify their approach to a given situation “on the fly”. The system and method are readily adaptable to simple sound/image trainer bot responses as well as the more complex and realistic sound, image, and movement trainer bot responses.

Although the invention has been described relative to specific embodiments thereof, there are numerous variations and modifications that will be readily apparent to those skilled in the art of operational environment management requiring interpersonal dialogue with citizens (that can be replicated in a training situation through a trainer bot) in light of the above teachings. It is therefore to be understood that, within the scope of the appended claims, the invention may be practiced other than as specifically described.

What is claimed:

1. A conflict de-escalation training system, comprising:
a reproducer of sound and images;
at least one device adapted to detect speech, proximity, and movement of a human trainee relative to said reproducer;
at least one database for storing trigger event definitions and natural language understanding (NLU) rules;
an intent analyzer, executed by the at least one hardware processor, for ascertaining an intent of the speech of the human trainee using said NLU rules;
a trigger analyzer, coupled to said at least one device and executed by at least one hardware processor, for generating a trigger enable flag when one of said trigger event definitions is satisfied by at least one of the speech, the proximity, and the movement of the human trainee;
a compliancy state generator, executed by the at least one hardware processor, for determining a state value when said trigger enable flag is generated, said state value being based on at least one of said intent of the speech, the proximity of the human trainee, and the movement of the human trainee, wherein said state value is indicative of a level of compliance of an imaginary individual being subjected to the speech, the proximity, and the movement of the human trainee; and
an output generator, coupled to said reproducer and executed by the at least one hardware processor, for generating a facial image and a speech response for the imaginary individual based on said state value, wherein said facial image and said speech response are provided to said reproducer for output thereby.

2. A conflict de-escalation training system as in claim 1, wherein said facial image comprises a video stream of facial images replicating facial movements of the imaginary individual coordinated with said speech response of the imaginary individual.

3. A conflict de-escalation training system as in claim 1, further comprising a base adapted to be supported on a ground surface in proximity to the human trainee, said reproducer being coupled to said base at a height above the ground surface.

4. A conflict de-escalation training system as in claim 1, further comprising:
a mobile base adapted for motorized movement on a ground surface in proximity to the human trainee, said mobile base including a support for positioning said reproducer at a height above the ground surface; and
a base-movement controller, executed by the at least one hardware processor, for controlling the motorized movement of said mobile base based on said state value.

5. A conflict de-escalation training system as in claim 1, further comprising:
a mobile base adapted for motorized movement on a ground surface in proximity to the human trainee;
a humanoid dummy coupled to said mobile base, said humanoid dummy including a head-shaped portion wherein said reproducer is mounted on said head-shaped portion at a height above the ground surface; and
a base-movement controller, executed by the at least one hardware processor, for controlling the motorized movement of said mobile base based on said state value.

6. A conflict de-escalation training system as in claim 1, further comprising:
a mobile base adapted for motorized movement on a ground surface in proximity to the human trainee;
a humanoid dummy coupled to said mobile base, said humanoid dummy including a torso-shaped portion and a head-shaped portion coupled to said torso-shaped portion wherein said reproducer is mounted on said head-shaped portion, said torso-shaped portion including mechanized arms for controlled movement; and
a base-and-arms movement controller, executed by the at least one hardware processor, for controlling the motorized movement of said mobile base and the controlled movement of said mechanized arms based on said state value.

7. A conflict de-escalation training system as in claim 1, further comprising a memory coupled to said at least one device for storing the speech, the proximity, and the movement of the human trainee for a selected period of time.

8. A conflict de-escalation training system as in claim 1, further comprising a rules generator, coupled to said at least one database and executed by the at least one hardware processor, for training the NLU rules using the speech of the human trainee.

9. A conflict de-escalation training method, comprising the steps of:
providing a reproducer of sound and images;
detecting speech, proximity, and movement of a human trainee relative to the reproducer;
ascertaining, by at least one hardware processor, an intent of the speech of the human trainee using natural language understanding (NLU) rules;
determining, by the at least one hardware processor, a state value based on at least one of said intent of the speech, the proximity of the human trainee, and the movement of the human trainee, wherein said state value is indicative of a level of compliance of an imaginary individual being subjected to the speech, the proximity, and the movement of the human trainee; and
generating, by the at least one hardware processor, a facial image and a speech response for the imaginary individual based on said state value, wherein said facial image and said speech response are provided to the reproducer for output thereby.

10. A conflict de-escalation training method according to claim 9, wherein said facial image comprises a video stream of facial images replicating facial movements of the imaginary individual, said method further comprising the step of coordinating, by the at least one hardware processor, said video stream with said speech response.

11. A conflict de-escalation training method according to claim 10, wherein the reproducer is mounted on a mobile motorized base, said method further comprising the step of controlling movement, by the at least one hardware processor of the mobile motorized base based on said state value in coordination with said video stream and said speech response based on said state value.

12. A conflict de-escalation training method according to claim 10, wherein the reproducer is mounted on a humanoid dummy coupled to a mobile motorized base and wherein the humanoid dummy includes mechanized arms, said method further comprising the step of controlling movement, by the at least one hardware processor, of the mobile motorized base and the mechanized arms based on said state value in coordination with said video stream and said speech response based on said state value.

13. A conflict de-escalation training method according to claim 9, further comprising the step of storing the speech, the proximity, and the movement of the human trainee for a selected period of time.

14. A conflict de-escalation training method according to claim 9, further comprising the step of training, by the at least one hardware processor, the NLU rules using the speech of the human trainee.

15. A conflict de-escalation training system, comprising:
a mobile base adapted for motorized movement on a ground surface in proximity to a human trainee;
a humanoid dummy coupled to said mobile base, said humanoid dummy including a torso-shaped portion and a head-shaped portion coupled to said torso-shaped portion, said torso-shaped portion including mechanized arms for controlled movement;
a reproducer of sound and video mounted on said head-shaped portion;
at least one device adapted to detect speech, proximity, and movement of the human trainee relative to said reproducer;
at least one database for storing trigger event definitions and natural language understanding (NLU) rules;
an intent analyzer, executed by the at least one hardware processor, for ascertaining an intent of the speech of the human trainee using said NLU rules;
a trigger analyzer, coupled to said at least one device and executed by at least one hardware processor, for generating a trigger enable flag when one of said trigger event definitions is satisfied by at least one of the speech, the proximity, and the movement of the human trainee;
a compliancy state generator, executed by the at least one hardware processor, for determining a state value when said trigger enable flag is generated, said state value being based on at least one of said intent of the speech, the proximity of the human trainee, and the movement of the human trainee, wherein said state value is indicative of a level of compliance of an imaginary individual being subjected to the speech, the proximity, and the movement of the human trainee; and
an output generator, coupled to said mobile base, said mechanized arms, and said reproducer, said output generator being executed by the at least one hardware processor to (i) generate a video stream of facial images replicating facial movements of the imaginary individual coordinated with said speech response of the imaginary individual based on said state value wherein said video stream and said speech response are provided to said reproducer for output thereby, and (ii) control the motorized movement of said mobile base and the controlled movement of said mechanized arms based on said state value.

16. A conflict de-escalation training system as in claim 15, further comprising a memory coupled to said at least one device for storing the speech, the proximity, and the movement of the human trainee for a selected period of time.

17. A conflict de-escalation training system as in claim 15, further comprising a rules generator, coupled to said at least one database and executed by the at least one hardware processor, for training the NLU rules using the speech of the human trainee.
